(19) United States
(12) Patent Application Publication
(10) Pub. No.: US 2010/0129070 A1
(43) Pub. Date: May 27, 2010

(54) REAR VIEW CAMERA MOUNTING ON A VEHICLE

(75) Inventors: Barugur S. Balasundaramohan, Farmington Hills, MI (US); Quan Cat, Farmington Hills, MI (US); Randy Johnson, Farmington Hills, MI (US)

Correspondence Address: YOUNG BASILE, 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 12/275,725

(22) Filed: Nov. 21, 2008

(51) Int. Cl. G03B 17/00

(52) U.S. Cl. 396/419

(57) ABSTRACT

A vehicle camera system includes a vehicle rear end body structure. The vehicle rear end body structure includes a license plate receiving area and a lamp receiving portion proximal to the license plate receiving area. A lamp assembly is coupled to the lamp receiving portion. The lamp assembly includes a lamp that is configured and arranged to illuminate at least a portion of the license plate receiving area. A camera is coupled to the lamp assembly. The camera is configured and arranged to capture an image of an area proximal to the vehicle rear end body structure.

### FIELD OF THE INVENTION

The present invention pertains to the field of camera systems for vehicles.

### BACKGROUND

A vehicle can include a camera, such as a rear-view camera, and images captured by the camera can be transmitted to a display screen on a console of the vehicle or at another location where a driver can easily see the display screen. As a result, the camera can provide the driver with a view that the driver would not otherwise be able to easily see. For example, the camera can provide a view of an area directly behind the vehicle but below a view provided by a rear view mirror.

Cameras can be included by manufacturers as standard or optional original equipment for vehicles. Occasionally, a manufacturer will introduce a camera for a new model year of a vehicle that was previously under production without the camera. Additionally, after market camera systems can be purchased for vehicles manufactured without camera systems.

### SUMMARY

An example of a camera system according to the invention includes a vehicle rear end body structure. The vehicle rear end body structure includes a license plate receiving area and a lamp receiving portion proximal to the license plate receiving area. A lamp assembly is coupled to the lamp receiving portion, and the lamp assembly includes a lamp configured and arranged to illuminate at least a portion of the license plate receiving area. A camera is coupled to the lamp, and the camera is configured and arranged to capture an image of an area proximal to the vehicle rear end body structure.

### BRIEF DESCRIPTION OF THE DRAWINGS

The description herein makes reference to the accompanying drawings wherein like reference numerals refer to like parts throughout the several views, and wherein:

FIG. 1 is a perspective view of an example of a vehicle including a camera system and a license plate light;

FIG. 2 is another perspective view of the vehicle of FIG. 1;

FIG. 3 is a perspective view of the camera system of FIG. 1;

FIG. 4 is a side view of the camera system of FIG. 1;

FIG. 5 is a front view of the camera system of FIG. 1;

FIG. 6 is a perspective view of an inside of a vehicle rear end body portion of the vehicle of FIG. 1;

FIG. 7 is a perspective view of another example of a camera system;

FIG. 8 is a perspective view of a third example of a camera system;

FIG. 9 is a perspective view of a fourth example of a camera system;

FIG. 10 is a perspective view of a fifth example of a camera system;

FIG. 11 is a perspective view of a sixth example of a camera system;

FIG. 12 is an end view of a vehicle including yet another example of a camera system; and

FIG. 13 is a schematic view of a camera system coupled, to a power source and a display.

### DETAILED DESCRIPTION

While some vehicles are originally manufactured to include cameras, oftentimes cameras are included as optional equipment for vehicles, with a vehicle manufacturer producing one model of a vehicle without a camera and another model of the same vehicle with a camera. The model of the vehicle with the camera may have to undergo additional manufacturing processes to install the camera. For example, a body panel of the vehicle with the camera may undergo an additional stamping process to create an aperture of other connection for installation of a camera. Similarly, additional wiring may be required to provide data and power connections to the camera. As a result, offering a camera as an option for a vehicle can require additional tooling for manufacturing the vehicle that can increase manufacturing costs.

Additionally, in the event a camera is introduced to a new model year of a vehicle that had previously been in production without a camera, tooling for the manufacturing vehicle already exists, but the tooling typically is not designed to accommodate the camera. As a result, introducing the camera in the new model year of the vehicle generally requires creating new tooling. For example, a new stamping process may be added to punch an aperture or other connection in a body panel for mounting the camera.

Similarly, most vehicles originally manufactured without cameras do not offer a convenient location for attaching a camera. Thus, attaching an after market camera system to a vehicle can require overcoming camera-mounting complications.

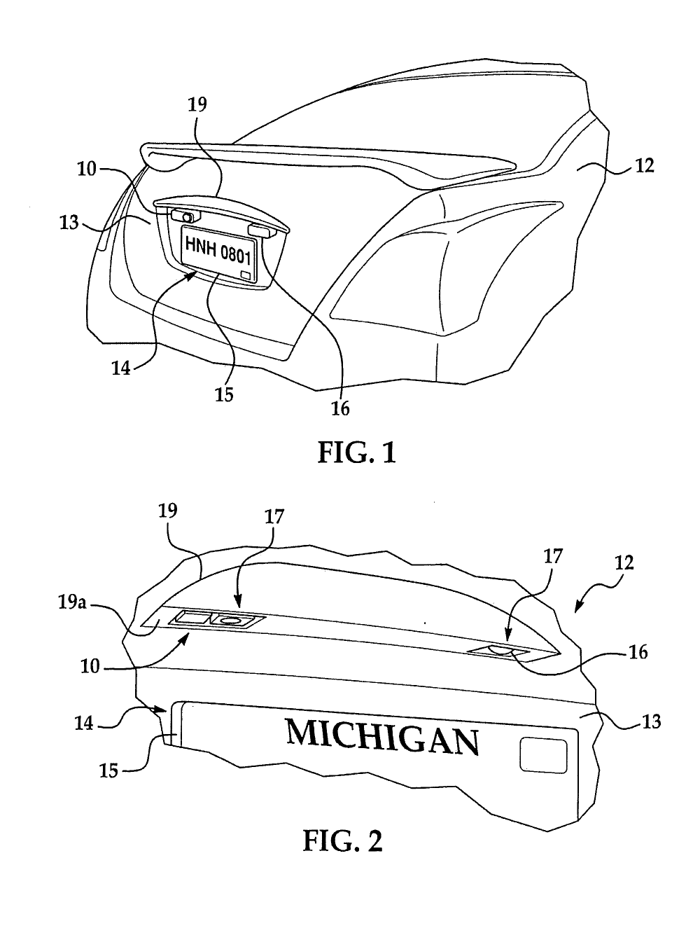

One of the camera systems described below with reference to FIGS. 1-13 can be easily mounted on a vehicle, such as by attaching the camera system to the vehicle at a position that can alternatively be occupied by a normal license plate light. FIGS. 1 and 2 show a camera system 10 coupled to a vehicle 12. The vehicle 12 can be a passenger automobile (e.g., a sedan or an SUV), a commercial vehicle (e.g., a truck or van), a trailer, or another type of vehicle. The vehicle 12 can include a rear end body structure 13 that defines a license plate receiving area 14 and lamp receiving portions 17. The rear end body structure 13 can include a vehicle body panel, an overhang above a license plate, a trunk decklid, a rear hatch of an SUV or truck, a rear bumper, another structure on the rear of a vehicle, or a combination thereof.

The license plate receiving area 14 as shown in FIGS. 1 and 2 can be generally planar and indented or otherwise offset from a surrounding portion of the rear end body structure 13. A license plate 15 can be mounted over the license plate receiving area 14 using screws, clips, or another coupling structure. The license plate receiving area 14 can define apertures for license plate screws or other structures (e.g., clips) for securing a license plate to the vehicle 12. While the license plate receiving area 14 is often on the rear of a vehicle and above or inline with a rear bumper, the license plate receiving area 14 can be any portion of the vehicle 12 configured to hold a license plate (e.g., the license plate receiving area 14 can be on a trunk decklid or a rear hatch of an SUV or truck, and the license plate area 14 need not be offset from a surrounding portion of the vehicle 12). For a symmetrical appearance, the license plate area 14 can be located along a lateral center of the vehicle 12.

The rear end body structure 13 as shown in FIG. 2 defines an overhang 19 having an underside 19a above the license plate receiving area 14. The lamp receiving portions 17 shown in FIG. 2 are inward of the underside 19a of the overhang 19, such that the objects attached thereto can be at least partially sheltered by the overhang 19. However, the lamp receiving portions 17 can be located at alternative positions, such as to the lateral sides of the license plate receiving area 14 or at another location adjacent the license plate receiving area 14. Also, the lamp receiving portions 17 as shown in FIG. 2 are offset from a lateral center of the vehicle 12 (i.e., a center of the license plate 15 shown as shown in FIG. 2). The lamp receiving portions 17 can be laterally offset by an equal amount for a symmetric appearance. The lamp receiving portions 17 are also proximal to the license plate receiving area 14, so that a light coupled to one of the lamp receiving portions 17 can be close enough to the license plate receiving area 14 to illuminate at least a portion of the license plate receiving area 14. While two lamp receiving portions 17 are shown, one lamp receiving portion 17 or more than two lamp receiving portions 17 can alternatively be included. The structure of the lamp receiving portions 17 is further discussed below in respect to FIG. 6.

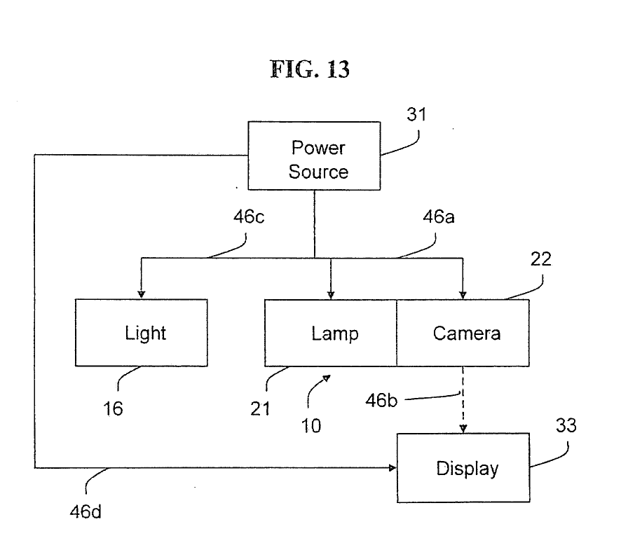

The vehicle 12 can also include a license plate light 16 coupled to one of the lamp receiving portions 17. As a result, the light 16 can be proximal the license plate receiving area 14, with the light 16 offset from the lateral center of the vehicle 12 such that the camera system 10 and light 16 are laterally spaced from the lateral center line ofthe vehicle 12 by an equal amount. The license plate light 16 can include an incandescent bulb, a halogen bulb, one or more LEDs, or another light source. The license plate light 16 can be configured and arranged to provide illumination for the license plate receiving area 14 supplemental to light provided by the camera system 10 by orienting the license plate light 16 to produce light toward the license plate receiving area 14 or by reflecting or refracting light produced by the license plate light 16 toward the license plate receiving area 14. The license plate light 16 can alternatively be mounted at a location other than above the license plate receiving area 14 as shown in FIG. 2, such as to a side of the license plate receiving area 14. While the license plate light 16 is optional, more than one license plate light 16 can also be included. The license plate light 16 can be wired to a vehicle electrical system to receive electrical power from a power source 31 (shown in FIG. 13) such as a vehicle alternator or battery.

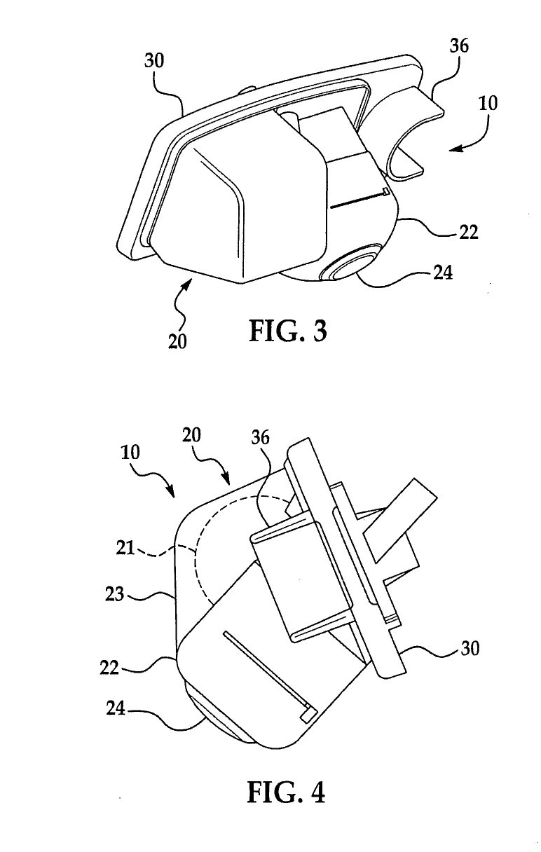

As shown in FIGS. 3-5, the camera system 10 can include a lamp assembly 20, a camera 22, and a bracket 30. The lamp assembly 20 can include a lamp 21 and a lens 23. The lamp 21 can be any type of light source, such as one or more LEDs, an incandescent bulb, a halogen bulb, or other device for producing light. The lamp 21 can be clipped, snap-fit, screwed, bolted, adhered, or otherwise attached to the lens 23 or the bracket 30. The lamp 21 can be configured and arranged to illuminate the license plate receiving area 14 by coupling the camera system 10 to the lamp receiving portion 17 such that the lamp 21 is oriented to produce light toward the license plate receiving area 14, or by reflecting or refracting light produced by the lamp 21 toward the license plate receiving area 14. While one lamp 21 is shown, each camera system 10 can include multiple lamps 21, such as an array of LEDs or multiple incandescent bulbs. Also, the lens 23 can house at least a portion of the camera 22.

The lens 23 can be a light transmitting housing enclosing the lamp 21. The lens 23 can be made from a light transmitting material such as polycarbonate, acrylic, or glass. That is, the lens 23 can be translucent or transparent. The lens 23 can be coupled to the bracket 30, such as by a snap fit, adhesive, screws, or another structure. Also, the lens 23 need not refract light to cause light to converge or diverge; the lens 23 can allow light to pass therethrough without altering its path. While the lamp 21 is illustrated as a separate component inside the lens 23, the lens 23 can alternatively be integral with the lamp 21.

The camera 22 can capture.images by receiving light via a camera lens 24. The camera 22 can capture still images, or the camera 22 can capture a sequence of moving images (i.e., video). The images can be color or black-and-white. The camera 22 can include an output to transfer a digital or analogue signal corresponding to captured images. The camera 22 can be clipped, snap-fit, screwed, bolted, adhered, or otherwise attached to the bracket 30, thereby coupling the lamp assembly 20 and the camera 22. However, the camera 22 can alternatively be coupled to the lamp assembly 20 by directly attaching the camera 22 to the lamp assembly 20, attaching the camera 22 and the lamp 20 assembly to adjacent portions of the rear end body structure 13, attaching both the camera 22 and lamp assembly 20 to a common housing or bracket, or by otherwise connecting the camera 22 and lamp assembly 20. The camera 22 can be angled to face generally rearward, though the camera 22 can be angled non-orthogonally relative to the license plate receiving area 14 (e.g., since the camera 22 can be offset from a lateral center of the vehicle 12, the camera 22 can be angled such that the image captured by the camera 22 appears to be laterally centered). Alternatively, the camera 22 can be oriented to face another direction which is not easily seen by a driver of the vehicle 12, such as a blind spot behind and lateral of the vehicle 12. The camera 22 can also include a motorized pivot to rotate a point of view along which images are captured, and the camera 22 can be connected to additional elements such as an obstacle detector or a CPU for processing images.

The bracket 30 shown in FIGS. 3-5 can serve as a backing for the lens 23. That is, a backside of the lens 23 can be open when the lens 23 is not coupled to the bracket 30, and the bracket 30 can span the open back of the lens 23 when attached to the lens 23. The bracket 30 can include brie or more apertures through which wiring or a wiring harness, such as wires 46 shown in FIG. 6, for the lamp 21 and/or camera 22 passes. Alternatively, the lamp 21 and/or camera 22 can have electrical connections that extend through the aperture in the bracket 30 to connect directly to the wiring or wiring harness of the vehicle 12.

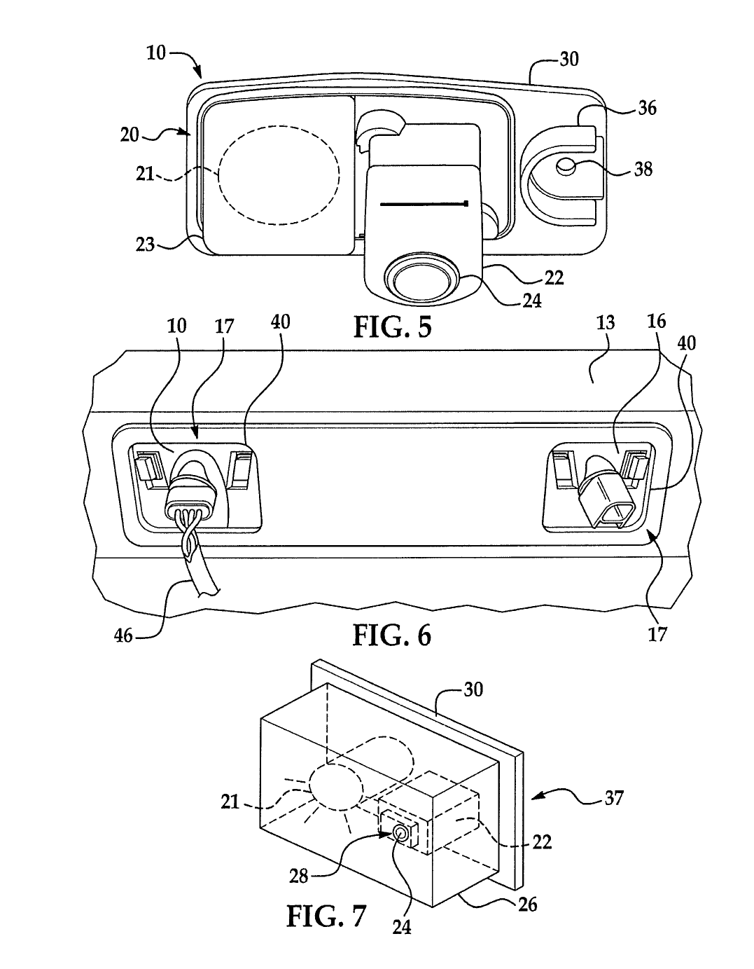

The bracket 30 can be shaped for attachment to the vehicle 12. For example, the illustrated bracket 30 can define a C-shaped flange 36 for providing stability to the system 10 when it is attached to the vehicle 12. The flange 36 can provide stability by receiving a circular shaped post attached to the vehicle 12 or another structure for preventing movement of bracket 30. The bracket 30 can further define an aperture 38 shown in FIG. 5 for receiving a screw or bolt for attaching the system 10 to the vehicle 12. The bracket 30 can alternatively be connected to the vehicle 12 using another attachment structure such as clips for a snap-fit connection to the vehicle 12, or the bracket 30 can be adhered to the vehicle 12. Additionally, the bracket 30 need not be a separate component. For example, the bracket 30 can be formed integrally with the lens 23 and/or a portion of the camera 22. As another alternative, the lamp assembly 20 and camera 22 can be attached directly to the vehicle 12, in which case no bracket 30 is necessary.

The lamp receiving portions 17 are shown in FIG. 6 from an opposing side of the rear end body structure 13 from the side shown in FIG. 2. The lamp receiving portions 17 can each define an aperture 40 or another attachment structure (e.g., a recessed area, a clip, a fixture coupled to the lamp receiving portion 17). As described above, the camera system 10 can be coupled to one of the lamp receiving portions 17, with the light 16 coupled to the other lamp receiving portion 17. Each aperture 40 can be proximal the license plate receiving area 14 (i.e., the apertures 40 can be close enough to the license plate receiving area 14 that light produced by a lamp attached thereto can illuminate at least part of the license plate receiving area 14). The apertures 40 can have a smaller size than the bracket 30 such that a portion of the bracket 30 abutting the vehicle end body structure 13 when the lamp assembly 20 and camera 22 extend through one of the apertures 40 can be connected to the vehicle end body structure 13. Additionally, electrical and/or data connections, such as wires 46 in communication with the lamp assembly 20 and/or camera 22 can pass through the aperture 40.

The lamp receiving portions 17 can both have been intended to hold lights 16 when originally designed. For example, on a previous model year of the vehicle 12 or on another version of the vehicle 12 without the camera system 10, the aperture 40 to which the camera system 10 is coupled can be used to secure one of the license plate lights 16 to the vehicle 12. In these cases, each license plate light 16 can be mounted on an original equipment bracket, and the aperture 40 can be shaped to receive the original equipment bracket. By making the bracket 30 compatible with the aperture 40, the camera system 10 can be installed at a location originally designed to receive one of the license plate lights 16.

Referring now to FIG. 13, the vehicle 12 can include a power source 31, such as a battery or alternator of a vehicle electrical system, and a display 33. The display 33 can include a screen on a console of the vehicle 12, a rear-view mirror of the vehicle 12, or elsewhere within a field of vision of a driver. The wires 46 that can pass through the aperture 40 and that can be coupled to the camera system 10 can include a power wire 46a and a data wire 46b, while another wire 46d can couple to the display 33 to the power source 31. The power wire 46a can couple the lamp 21 and camera 22 to the power source 31. Also, the power wire 46a can alternatively be coupled to another light 16 in another model of a vehicle not including a camera system 10, such mat a different wiring system is not necessary for a manufacturer to produce a model of the vehicle 12 with the camera system 10 and a model without the camera system 10. The data wire 46b can couple the camera 22 to the display 33, and a signal created by the camera 22 corresponding to an image of an area behind the vehicle 12 can be transmitted to the display 33. As a result, the image of the area behind the vehicle 12 can be displayed to a driver. Alternatively, instead of a physical data wire 46b, the camera 22 can wirelessly transmit the signal to the display 33 (e.g., using a standard wireless protocol such as IEEE 802.11 or Bluetooth). The wires 46 can also include another power wire 46c coupling the light 16 to the power source 31, and the power wire 46c can split from the power wire 46a and the data wire 46b prior to the power wires 46a passing through the aperture 40.

While FIGS. 3-5 show a camera system 10 including a lens 23 that encloses a lamp 21 but not the camera 22, other embodiments of camera systems can have alternative configurations. A camera system 37 shown in FIG. 7 includes the camera 22, lamp 21, and bracket 30. However, a lens 26 coupled to the bracket 30 encloses both the camera 22 and the lamp 21. Like the lens 23, the lens 26 can be made of a light transmitting material and can be coupled to the bracket 30, which can act as a backing plate for the lens 26. The lens 26 can define an aperture 28, and a distal end of the camera 22 (shown in FIG. 7 as a portion of the camera 22 including the camera lens 24) can be generally flush with the aperture 28. That is, the depth of the lens 26 can be substantially the same as a length of the camera such that the camera 22 extends approximately an equal distance from the bracket 30 as does the side of the lens 26 defining the aperture 28. Also, the aperture 28 can have a size corresponding to a perimeter of the camera lens 24. A seal, e.g., a rubber O-ring, can be placed between the camera lens 24 and the aperture to prevent moisture or other contaminants from entering the lens 26. The lens 26 can also include other structures, such as a reflector or refraction surface for altering a path of light produced by the lamp 21. As a result, the camera lens 24 can capture images without the lens 26 altering a path of light entering the camera lens 24.

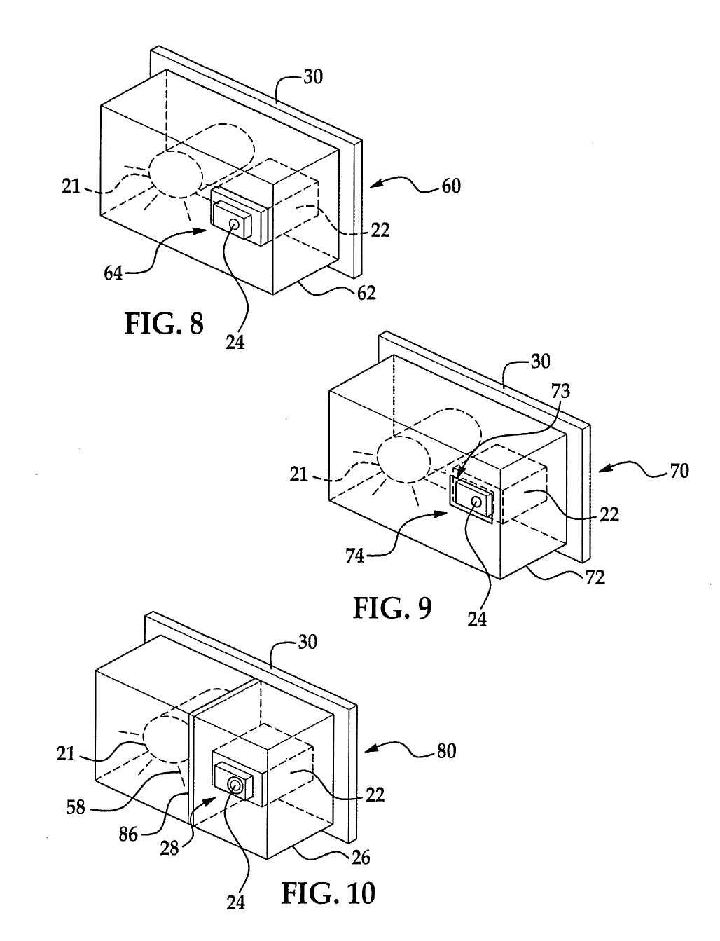

Another example of a camera system 60 as shown in FIG. 8 includes the lamp 21 and the camera 22, both coupled to the bracket 30. The camera system 60 includes a lens 62 defining an aperture 64. The lens 62 is similar to the lens 26, except the relationship between the depth of the lens 62 and length of the camera 22 is such that the distal end of the camera 22 (shown in FIG. 8 as a portion of the camera 22 including the camera lens 24) extends through the aperture 64. While the aperture 64 is illustrated as having a shape corresponding to a perimeter of the camera 22, a perimeter of the aperture 64 can be larger than a perimeter of the camera 22 in the region of the aperture 64 such that the camera 22 can pivot if mounted on the motorized pivot as mentioned above. In this case, the camera 22 can be pivoted without the lens 62 interfering with light entering the camera lens 24.

Yet another example of a camera system 70 as shown in FIG. 9 includes the lamp 21 and the camera 22, both coupled to the bracket 30. The camera system 70 includes a lens 72 defining an aperture 74. The lens 72 is similar to the lens 26, except the relationship between the depth of the lens 72 and the length of the camera 22 is such that the distal end of the camera 22 (shown in FIG. 9 as a portion of the camera 22 including the camera lens 24) is recessed beneath an inner surface 73 of the lens 72. That is, as shown in FIG. 9, a distance from the bracket 30 to the inner surface 73 of the lens 72 is greater than a distance from the bracket 30 to any portion of the camera 22. The camera lens 24 can be aligned with the aperture 74 such that light can pass directly into the camera lens 24 through the aperture 74 without passing through the lens 72. The aperture 74 can be sized to allow light to pass from an imaged area behind the vehicle 12 into the camera lens 24 without passing through the lens 72, thereby preventing possible distortion in the image. Also, a frustoconical seal can extend between the camera lens 24 and the aperture 74. By sizing the lens 72 such that the camera lens 24 is recessed, the lens 72 can protect the camera lens 24 of the camera 22. Also, when the distance between bracket 30 and inner surface 73 of the lens 72 is greater than the distance from the bracket to any portion of the camera 22, the lens 72 need not include the aperture 74. That is, the camera 22 can be encased in the lens 72, and the lens 72 can protect both the lamp 21 and camera 22.

Still yet another example of a camera system 80 as shown in FIG. 10 is the same as the camera system 37 as shown in FIG. 7, except the camera system 80 includes a separator 86 between the lamp 21 and the camera 22. The separator 86 can be positioned to block a path of light 58, which can be direct or indirect (e.g. a path including.a reflection or refraction), from the lamp 21 to the camera lens 24. For example, the separator 86 can extend from the bracket 30 to a side of the lens 26 defining the aperture 28. The separator 86 can be, as example, a separate piece attached to the bracket 30, molded integrally with the bracket 30 or lens 26, or attached to the camera 22. The separator 86 can be opaque, reflective, or otherwise prevent at least a portion of light produced by the lamp 21 in the path of light 58 from reaching the camera lens 24.

Also, while the separator 86 is shown as perpendicular to the bracket 30, the separator 86 can have a different configuration (e.g., the separator 86 can be non-orthogonal relative to the bracket 30). The angle of the separator 86 relative to the bracket 30 can affect the amount of light received by the camera 22 and/or the amount of light produced by the lamp 21 that reaches the license plate receiving area 14. For example, in comparison to a separator 86 extending orthogonally from the bracket 30, an alternative separator 86 can be angled toward the camera 22 and away from the lamp 21 to allow more light produced by the lamp 21 to reach the license plate receiving area 14 while reducing the area of the image captured by the camera 22. As another example, if the separator 86 is angled away from the camera 22, the camera 22 may be able to capture images of a larger area behind the vehicle 12 and a lesser amount of light prodviced by the lamp 21 may reach the license plate receiving area 14. The separator 86 can be included with any of the camera systems described herein, and the light path altering affect caused by the angle of the separator 86 may be especially pronounced when included on a camera system in which the separator 86 has a length greater than a length of the camera 22 (e.g., if the separator 86 were included in the camera system 70 as shown in FIG. 9).

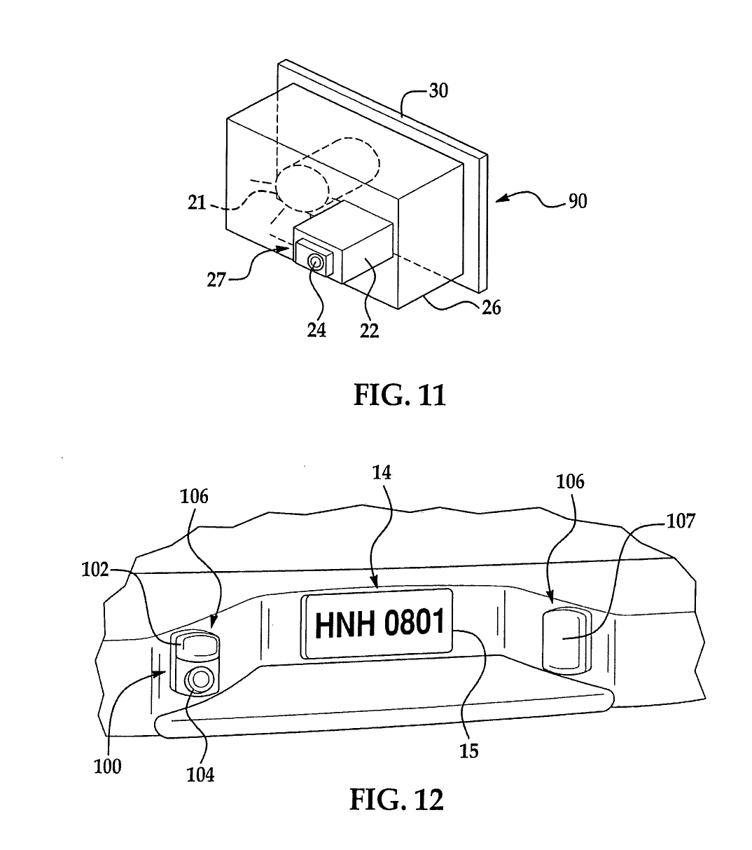

An additional example of a camera system 90 as shown in FIG. 11 includes the lamp 21, the camera 22, and the lens 26. However, the camera 22 is coupled to an outside surface 27 of the lens 26. In this case, the camera 22 can include an integral protective casing since it is not enclosed by the lens 26. Additionally, the camera 22 can be mounted on a pivot as mentioned above in order to capture images in different directions (e.g., images of blind spots on both sides of the vehicle 12 and directly behind the vehicle 12). By mounting the camera 22 to the outside surface 27 of the lens 26, the camera 22 can be free to pivot without interference from the lens 26.

While the camera system 10 as shown in FIGS. 1-6 is described as being attached to one of the lamp receiving portions 17 above the license plate receiving area 14, another example of a light receiving portion can be located at another position relative to the license plate, receiving area. For example, FIG. 12 shows a camera system 100 including a lamp 102 and a camera 104. The camera system 100 can have a shape similar to a standard license plate light 107, such that both the camera system 100 and the standard light 107 can be attached to similarly shaped lamp receiving portions 106, which are located laterally from the license plate receiving area 14 as shown in FIG 12. The lamp 102 and camera 104 can be oriented such that when the camera system 100 is attached to the lamp receiving portion 106 laterally from the license plate receiving area 14, the lamp 102 can produce light toward the license plate receiving area 14 and the camera 104 can capture an image behind the vehicle. That is, not only can a lamp receiving portion be at any location proximal the license plate receiving area 14, but a lamp and a camera of a camera system can be oriented differently depending on the relative position of the lamp receiving portion to the license plate receiving area 14.

Among other advantages, the camera systems as described herein, e.g. camera system 10, can be installed on the lamp receiving portion 17 of the vehicle 12. Since the lamp receiving portion 17 can be originally designed for accepting a standard license plate light 16, the camera system 10 can easily installed.on the vehicle 12. For example, modification of the lamp receiving portion 17 can be avoided, thereby eliminating the need for additional tooling to modify the vehicle end body structure 13. As another example, wiring 46 originally intended for the license plate light 16 can be used to power both the lamp 20 and camera 22.

While the invention has been described in connection with what is presently considered to be the most practical and preferred embodiment, it is to be understood that the invention is not to be limited to the disclosed embodiments but, on the contrary, is intended to coyer various modifications and equivalent arrangements included within the spirit and scope of the appended claims, which scope is to be accorded the broadest interpretation so as to encompass all such modifications and equivalent structures as is permitted under the law. What is claimed:

1. A vehicle camera system comprising:
a vehicle rear end body structure comprising:
a license plate receiving area; and
a lamp receiving portion proximal to the license plate receiving area;
a lamp assembly coupled to the lamp receiving portion, the lamp assembly including a lamp configured and arranged to illuminate at least a portion of the license plate receiving area; and
a camera coupled to the lamp assembly, the camera configured and arranged to capture an image of an area proximal to the vehicle rear end body structure.

2. The vehicle camera system of claim 1, wherein the lamp assembly further includes a lamp lens configured and arranged to cover the lamp and, permit transmission of light from the lamp to the license, plate receiving area.

3. The vehicle camera system of claim 2, wherein the camera is coupled to the lamp lens.

4. The vehicle camera system of claim 2, wherein the lamp lens defines an aperture, and wherein a distal end of the camera is substantially flush with the aperture.

5. The vehicle camera system of claim 2, wherein the lamp lens defines an aperture, and wherein a portion of the camera extends through the aperture.

6. The vehicle camera system of claim 2, wherein the lamp lens defines an inner surface, and wherein the camera is spaced inboard of the inner surface of the lamp lens.

7. The vehicle camera system of claim 2, wherein the lens defines an outer surface, and the camera is disposed on the outer surface of the lens.

8. The vehicle camera system of claim 1, further comprising a separator positioned between the lamp and the camera, the separator blocking a path of light from the lamp toward a lens of the camera.

9. The vehicle camera system of claim 1, further comprising a power source electrically coupled to both the lamp and the camera.

10. The vehicle camera system of claim 1, wherein the lamp receiving portion is spaced horizontal apart from of the license plate receiving area.

11. The vehicle camera system of claim 1, further comprising:
a display, and
wherein the camera is configured and arranged to provide the image to the display

12. The vehicle camera system of claim 11, wherein the camera provides the image to the display wirelessly.

13. The vehicle camera system of claim 1, wherein the lamp assembly further comprising a bracket supporting the lamp.

14. The vehicle camera system of claim 13, wherein the bracket defines a rear surface of the lamp assembly.

15. The vehicle camera system of claim 13, wherein the bracket has a shape corresponding to the lamp receiving portion.

16. The vehicle camera system of claim 1, further comprising
an electrical connection coupled to the lamp and camera, and
wherein the electrical connection passes through an aperture defined by the lamp receiving portion.

17. The vehicle camera system of claim 16, wherein the lamp assembly conceals the aperture defined by the lamp receiving portion when the lamp assembly is coupled to the lamp receiving portion.

18. The vehicle camera system of claim 1, wherein the vehicle rear end structure defines a portion of a trailer vehicle coupled to a lead vehicle.

19. The vehicle camera system of claim 1, wherein the camera is non-orthogonally oriented with respect to the license place receiving area.

20. The vehicle camera system of claim 1, wherein the camera is spaced apart from a lateral center of the vehicle rear end body structure.
